(19) United States
(12) Patent Application Publication
(10) Pub. No.: US 2024/0335899 A1
(43) Pub. Date: Oct. 10, 2024

(54) RESISTANCE SPOT WELDING MACHINE AND RESISTANCE SPOT WELDING METHOD

(71) Applicant: KABUSHIKI KAISHA KOBE SEIKO SHO (KOBE STEEL, LTD.), Kobe-shi (JP)

(72) Inventor: Yoichiro SHIMODA, Kanagawa (JP)

(73) Assignee: KABUSHIKI KAISHA KOBE SEIKO SHO (KOBE STEEL, LTD.), Kobe-shi (JP)

(21) Appl. No.: 18/700,048

(22) PCT Filed: Oct. 14, 2022
(86) PCT No.: PCT/JP2022/038491

§ 371 Date: Apr. 10, 2024

(30) Foreign Application Priority Data
Oct. 15, 2021 (JP) 2021-169865

(51) Int. Cl. B23K 11/11

(52) U.S. Cl. CPC B23K 11/115

(57) ABSTRACT

A resistance spot welding machine contains a pair of electrodes each having an electrode tip to sandwich a plurality of steel sheets; and an angle correction mechanism that is provided in at least one of the pair of electrodes and that is capable of correcting the angle of the electrode tip to the steel sheets. The resistance spot welding machine spot welds the plurality of steel sheets by sandwiching the plurality of steel sheets with the pair of electrode tips and applying current while a welding force is applied to the pair of electrode tips, and the angle correction mechanism has a pair of universal joints each having an engaging portion having an end with a convex spherical shape and an engaged portion having a concave spherical shape to which the engaging portion fits slidably.

### TECHNICAL FIELD

The present invention relates to a resistance spot welding machine and a resistance spot welding method.

### BACKGROUND ART

Recently, to decrease the weight of the body for the purpose of reducing the emission of CO₂ and to enhance the collision safety, high tensile strength steel (HTSS) sheets are widely used for the body frame of an automobile or the like. Moreover, for assembly of the body of an automobile, attachment of components and the like, resistance spot welding is mainly used, and resistance spot welding is also applied for welding high tensile strength steel sheets.

For steel sheets for an automobile, galvanized high tensile strength steel sheets with excellent corrosion resistance are also often used for rust prevention. However, it is known that, when resistance spot welding is conducted using a galvanized high tensile strength steel sheet, grain boundary embrittlement cracking called LME (Liquid Metal Embrittlement), in which zinc melted on the surface of the steel sheet at the welded point or an alloy of zinc and copper of the electrode enters the austenitic grain boundary of the steel sheet and decreases the grain boundary strength, is easily caused. Because the strength of the welded part decreases and because the reliability of the resistance spot welded joint decreases when such cracking is caused, measures in operation are required.

Patent Literature 1 discloses a resistance spot welding method which has a welding step for applying current while pressure is applied with a welding force F1 with welding electrodes and a cooling step for holding at a welding force F2 from immediately after the completion of the current application and in which the welding forces satisfy the relation F2>F1×2 to enable suppression of LME cracking.

Moreover, Patent Literature 2 discloses a resistance spot welding method which is capable of suppressing LME cracking by appropriately regulating the welding force holding time after the completion of the current application.

Furthermore, Patent Literature 3 discloses a spot welding machine in which a flanged rod is inserted into a tubular socket screwed into a base member of one of the electrodes and in which a convex spherical surface provided at an end of the flanged rod is in contact with a receiving surface of the base member. The center of the oscillation of the convex spherical surface of the flanged rod is located substantially close to the center of the flanged rod, and LME cracking is suppressed by suppressing the shift from the original position of the electrode tip provided at the end of the flanged rod.

Moreover, Patent Literature 4 discloses an electrode for a spot welding gun in which a first electrode shank having an electrode tip on one end is connected to a second electrode shank with an elastically deformable connection member and in which LME cracking can be suppressed because the connection member elastically deforms to keep the angle of the electrode and the steel sheets perpendicular when the electrode tip comes into contact with the steel sheets at a tilt angle.

### CITATION LIST

### Patent Literature

Patent Literature 1: JP2019-171450A
Patent Literature 2: WO2017/033455
Patent Literature 3: Microfilm of Japanese utility model application No. S58-168076 (JPS60-74871U)
Patent Literature 4: JP3226182Y

### SUMMARY OF INVENTION

### Technical Problem

Here, the spot welding machines described in Patent Literatures 3 and 4 suppress LME cracking by allowing the electrode tip of an electrode oscillate to suppress the tilt angles of the upper and lower electrodes to the steel sheets and thus reducing the tensile stress.

In the spot welding machine described in Patent Literature 3, however, the electrode tip may shift relative to the steel sheets when the steel sheets are tilted based on the axis of the electrode because the flanged rod turns around the oscillation center of the convex spherical surface to correct the tilt angle, and thus LME cracking may still occur.

In the welding gun described in Patent Literature 4, a pair of electrode shanks are connected with an elastically deformable connection member (spring), and thus the tilt angle of the electrode tip to the steel sheets is corrected even when the steel sheets are tilted relative to the axis of the electrode to suppress the difference of the axes of the pair of electrode tips. However, because the wire supplying a welding current to the electrode tip is located outside the pair of electrode shanks, the wire sometimes hinders welding of a narrow part, and it has been desired to make the electrode compact.

Here, the spot welding methods described in Patent Literatures 1 and 2 do not have any mechanism of oscillating the electrode tip, and suppression of LME cracking in the case of a tilt angle is not considered at all.

The invention has been made in view of the problems above, and an object is to provide a resistance spot welding machine which can correct the tilt angle of the electrode tip to the steel sheets even when the steel sheets are tilted relative to the axis of the electrode and in which the electrodes are made compact and a resistance spot welding method.

### Solution to Problem

Thus, the object of the invention is achieved by the configuration of [1] below related to a resistance spot welding machine.

[1] A resistance spot welding machine contains
a pair of electrodes each having an electrode tip to sandwich a plurality of steel sheets, and
an angle correction mechanism that is provided in at least one of the pair of electrodes and that is capable of correcting the angle of the electrode tip to the steel sheets and in which the resistance spot welding machine spot welds the plurality of steel sheets by sandwiching the plurality of steel sheets with the pair of electrode tips and applying current while a welding force is applied to the pair of electrode tips,
in which the angle correction mechanism has a pair of universal joints each having an engaging portion having an end with a convex spherical shape and an engaged portion having a concave spherical shape to which the engaging portion fits slidably, and
the electrode is capable of applying current to the electrode tip through the pair of universal joints.

Moreover, the object of the invention is achieved by the configuration of [2] below related to a resistance spot welding method.

[2] A resistance spot welding method for spot welding a plurality of steel sheets including a galvanized steel sheet and a steel sheet containing 0.08 mass % or more of C and 0.50 mass % or more of Si and having a tensile strength of 980 MPa or more or a plurality of steel sheets having at least one galvanized steel sheet containing 0.08 mass % or more of C and 0.50 mass % or more of Si and having a tensile strength of 980 MPa or more
using the resistance spot welding machine described in [1].

### Advantageous Effects of Invention

According to the resistance spot welding machine of the invention, the tilt angle of the electrode tip to the steel sheets can be corrected even when the steel sheets are tilted relative to the axis of the electrode, and a compact electrode can be configured.

Moreover, according to the resistance spot welding method of the invention, occurrence of LME cracking in the pressure welded part of a resistance spot welded joint can be suppressed in resistance spot welding of a plurality of steel sheets including a galvanized steel sheet and a high tensile strength steel sheet or a plurality of steel sheets including a galvanized high tensile strength steel sheet.

### BRIEF DESCRIPTION OF DRAWINGS

FIG. 1 is a side view of the resistance spot welding machine according to an embodiment of the invention.

FIG. 2 is a perspective view of the electrode illustrated in FIG. 1.

FIG. 3 is a side view of the electrode illustrated in FIG. 1.

FIG. 4A is a vertical cross sectional view of the electrode illustrated in FIG. 3.

FIG. 4B is an enlarged cross sectional view of the IVB part of FIG. 4A.

FIG. 5 is a schematic figure explaining the process in which the electrode having a pair of universal joints according to the embodiment corrects the tilt angle to be substantially perpendicular to tilted steel sheets.

FIG. 6A is a side view illustrating the state in which the pair of electrodes according to the embodiment are in contact with tilted steel sheets.

FIG. 6B is a side view illustrating the state in which the pair of electrodes are in contact with the steel sheets substantially perpendicularly due to the action of the respective universal joints and in which the tilt angles of both electrodes are thus corrected after the state illustrated in FIG. 6A.

FIG. 7 is a schematic figure explaining the process in which an electrode having one universal joint corrects the tilt angle to be substantially perpendicular to tilted steel sheets.

FIG. 8 includes cross sectional views showing and comparing the joints by resistance spot welding using a conventional resistance spot welding machine in which the pair of electrodes are both rigid electrodes and the joints by resistance spot welding using the resistance spot welding machine according to the embodiment.

### DESCRIPTION OF EMBODIMENTS

Hereinafter, an embodiment of the resistance spot welding machine and the resistance spot welding method according to the invention is explained in detail based on the drawings.

Here, the resistance spot welding machine of the embodiment is for spot welding a plurality of metal sheets (steel sheets) but is particularly preferably used for spot welding a plurality of steel sheets M having at least one galvanized steel sheet containing 0.08 mass % or more of C and 0.50 mass % or more of Si and having a tensile strength of 980 MPa or more (namely a galvanized high tensile strength steel sheet). Moreover, the resistance spot welding machine of the embodiment is also preferably used for spot welding a plurality of steel sheets M having an ordinary galvanized steel sheet, such as galvanized mild steel, and a non-galvanized high tensile strength steel sheet containing 0.08 mass % or more of C and 0.50 mass % or more of Si and having a tensile strength of 980 MPa or more in contact with the steel sheet.

Here, examples of the galvanized steel sheets include a hot-dip galvannealed steel sheet (GA), a hot-dip galvanized steel sheet (GI), an electro galvanized steel sheet (EG) and the like.

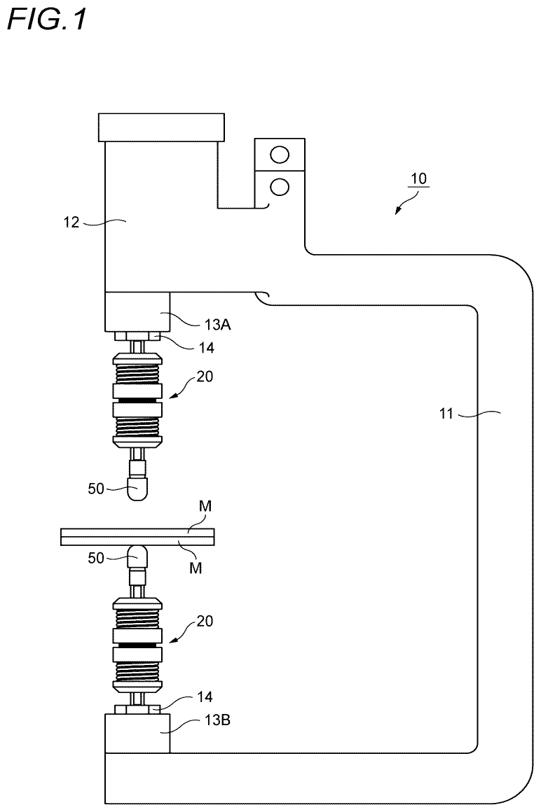

As illustrated in FIG. 1, the resistance spot welding machine 10 of the embodiment has a frame 11 having a substantial C shape in a plan view, a pressurizing cylinder 12 provided at an end of the frame 11, two bases 13A and 13B provided on the facing ends of the frame 11 and the pressurizing cylinder 12, an electrode 20 on a movable side provided on the base 13A on the movable side and an electrode 20 on a fixed side provided on the base 13B on the fixed side. Here, the electrode 20 on the movable side and the electrode 20 on the fixed side are arranged to face each other on a same axis.

Here, when spot welding is conducted, a plurality (two pieces in the figure) of stack steel sheets M, which are members to be joined, are inserted between the electrode 20 on the movable side and the electrode 20 on the fixed side, and the steel sheets M are brought into contact with the electrode 20 on the fixed side. In this state, the electrode 20 on the movable side is advanced downward in the figure with the pressurizing cylinder 12, and thus the steel sheets M are sandwiched between the pair of electrodes 20 and 20. Current is applied between the pair of electrodes 20 and 20 in this state under pressure, and spot welding is thus conducted.

Here, because the electrode 20 on the movable side and the electrode 20 on the fixed side have a same structure, only the electrode 20 on the movable side will be explained in the explanation below.

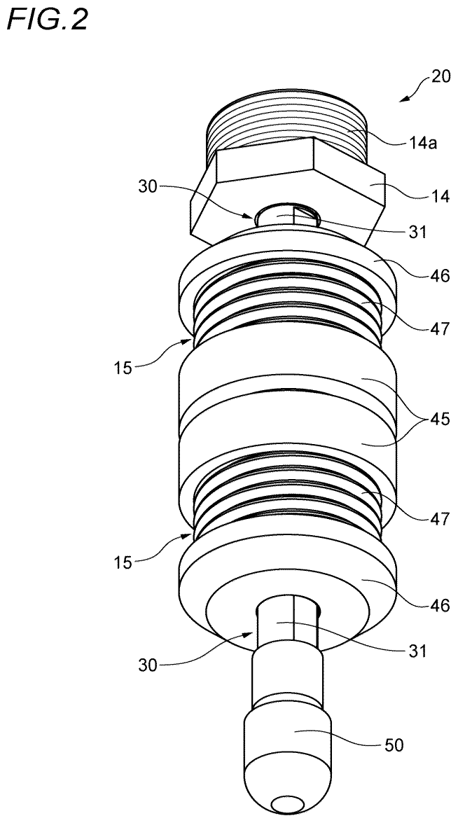

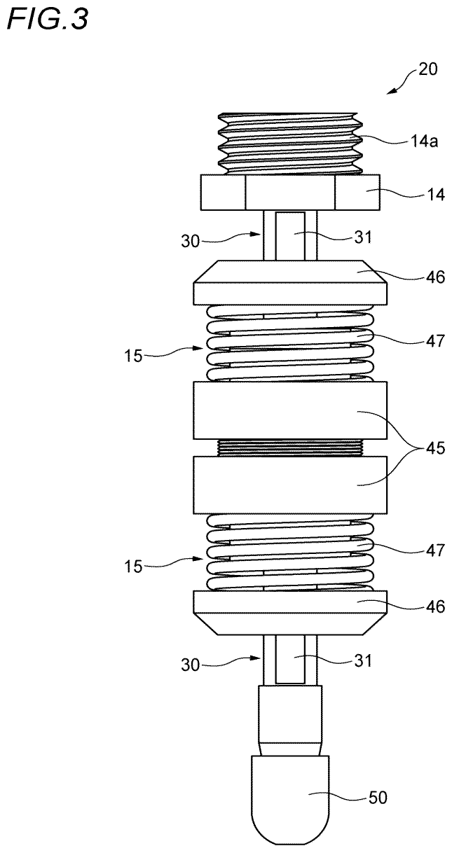

As illustrated in FIG. 2 to FIG. 4B, the electrode 20 has a pair of universal joints 30 which is an angle correction mechanism, a pair of spring mechanisms 15 which are provided in the pair of universal joints 30 respectively, an electrode tip 50 which comes into contact with the steel sheets M and a fixing portion 14 for attaching to the base 13A or 13B.

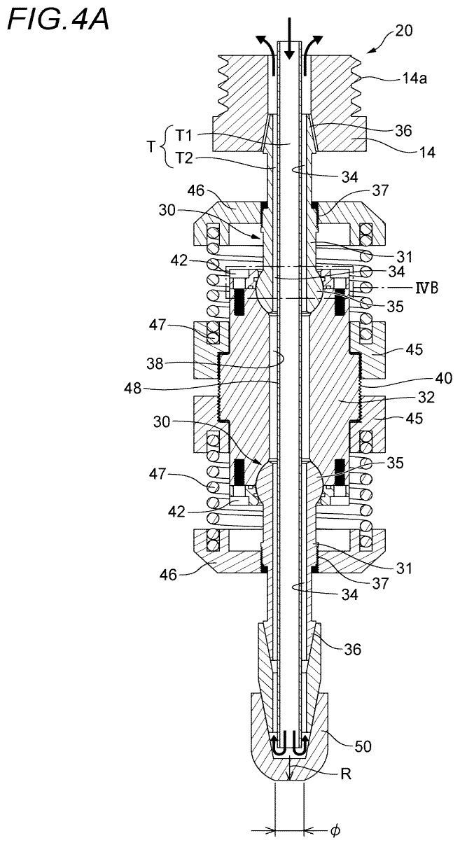

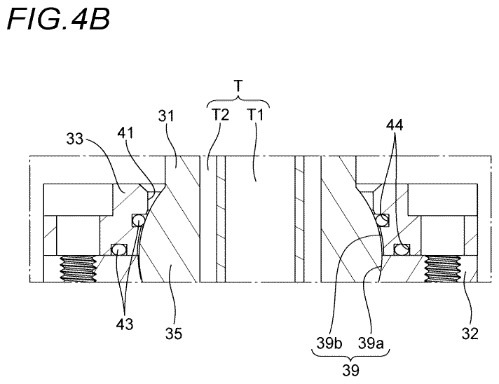

Moreover, as illustrated in FIG. 4A and FIG. 4B, the pair of universal joints 30 each have a first shaft 31, a second shaft 32 and a cover member 33 and are each assembled in one by these. Here, the pair of universal joints 30 share the second shaft 32 as a common single member, are horizontally symmetrical around the middle in the axial direction of the second shaft 32 and have a same structure, and the pair of spring mechanisms 15 have a same structure above and under the middle in the axial direction of the second shaft 32.

Each first shaft 31 is a column member in which a through hole 34 which runs through in the axial direction is formed. An engaging portion 35 which is formed with an outer shape of a convex spherical shape is provided on an end of the first shaft, and a tapered portion 36 which is tapered is provided on the other end. The electrode tip 50 is fixed on the tapered portion 36 of the first shaft 31 that is located at the side of the steel sheets M, and a fixing portion 14 is fixed on the tapered portion 36 of the other first shaft 31, which is located at the pressurizing cylinder 12 side. A male screw 14a formed on the fixing portion 14 is screwed into a female screw, which is not illustrated, of the base 13A and is fixed on the base 13A. A male screw portion 37 is formed on the external side in the middle in the axial direction of the first shaft 31.

The second shaft 32 is a column member having a larger outer diameter than the outer diameters of the first shafts 31 and has a through hole 38 which runs through in the axial direction, and hemispheric concavities 39a formed in a concave spherical shape are formed on both ends in the axial direction. A male screw portion 40 is provided on the external side in the middle in the axial direction of the second shaft 32.

In this embodiment, the inside diameter of the through hole 38 is slightly larger than the inside diameters of the through holes 34 of the first shafts 31.

Each cover member 33 is a disk member having substantially the same outer diameter as the outer diameter of the second shaft 32, has the same curvature radius as that of the hemispheric concavity 39a of the second shaft 32 and has a hole portion 41 on which a hemispheric concavity 39b with a concave spherical shape is partially formed. The shaft of the first shaft 31 is inserted into the hole portion 41 of the cover member 33, and the hemispheric concavity 39b of the cover member 33 is fitted to a part of the engaging portion 35 of the first shaft 31. Then, the remaining part of the engaging portion 35 is fitted to the hemispheric concavity 39a of the second shaft 32, and the cover member 33 is fixed on both ends in the axial direction of the second shaft 32 with a screw 42. As a result, the hemispheric concavity 39b of the cover member 33 and the hemispheric concavity 39a of the second shaft 32 form the engaged portion 39 with a convex spherical shape.

Thus, the engaging portion 35 with a convex spherical shape fits slidably to the engaged portion 39 with a concave spherical shape. That is, the pair of universal joints 30 to which the first shafts 31 fit turnably are formed on both ends in the axial direction of the second shaft 32. Here, each universal joint 30 is configured in such a manner that, when the first shaft 31 bends relative to the second shaft 32, the first shaft 31 does not bend further beyond a predetermined angle because the shaft of the first shaft 31 interferes with the hole portion 41 of the cover member 33.

Moreover, as illustrated in FIG. 4B, in the cover member 33, O-ring grooves 44 for inserting O-rings 43 are formed on the inner surface of the hemispheric concavity 39b and the contact surface with the second shaft 32. The O-rings 43 prevent cooling water described below from leaking from the part on which the engaging portion 35 with a convex spherical shape is in slidingly contact with the hemispheric concavity 39b and from the contact part of the cover member 33 and the second shaft 32.

Furthermore, as illustrated in FIG. 4A, the through holes 34 and 34 of the pair of first shafts 31 are connected with the through hole 38 of the second shaft 32, and a tube 48 of Teflon (registered trademark) or the like is inserted through the through holes 34, 38 and 34.

The through holes 34, 38 and 34 and the tube 48 form a flow path T for cooling water for cooling the electrode tip 50. Specifically, the tube 48 forms a forward path T1, and the space between the tube 48 and the through holes 34, 38 and 34 forms a backward path T2. The cooling water that is supplied from the main body of the spot welding machine, which is not illustrated, and that is sent to the forward path T1 from the fixing portion side flows in the direction of the arrow illustrated in FIG. 4A, cools the electrode tip 50, then passes through the backward path T2 and returns to the main body of the spot welding machine.

Next, the pair of spring mechanisms 15 of the electrode 20 each have a first spring bearing 45 and a second spring bearing 46. The first spring bearings 45 are screwed with the male screw portion 40 formed in the middle in the axial direction of the second shaft 32 and fixed on the second shaft 32. The second spring bearings 46 are screwed with the respective male screw portions 37 of the pair of first shafts 31 and fixed on the first shafts 31. A coil spring (a compression spring or a tension spring) 47 which is an elastic member is equipped between the first spring bearing 45 and the second spring bearing 46.

The coil spring 47 is located between the first shaft 31 and the second shaft 32 around the first shaft 31 and the second shaft 32 through the first spring bearing 45 and the second spring bearing 45 and biases the first shaft 31 in a direction of separation from the second shaft 32 with the elastic force. The elastic force of the coil spring 47 acts to elastically deform when the universal joint 30 bends and align the first shaft 31 and the second shaft 32 in a straight line when the pressure force is removed.

The first shafts 31, the second shaft 32 and the cover members 33 are each composed of a conductive material having conductivity made of a metal (alloy) such as brass and act as conductive paths for the welding current. As a result, it is not necessary to separately provide an exclusive conductive path located outside the shanks for the pair of electrodes as shown in Patent Literature 4 for example, and a compact electrode 20 can be configured.

The electrode tip 50 has a curvature radius R of the end surface of 40 mm or more (R≥40 mm) and has a diameter (outer diameter) φ of the end surface of 16 mm or less (φ≤16 mm) (see FIG. 4A). As a result, the electrode tip 50 is prevented from being partially in contact with the steel sheets M and comes into contact certainly.

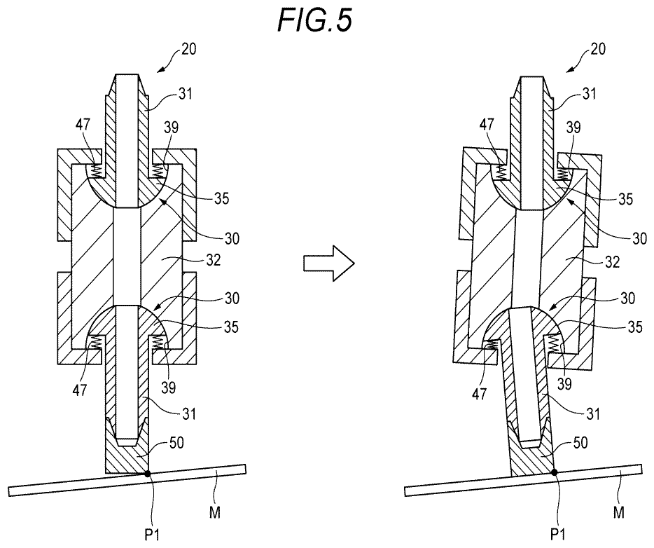

The electrode tip 50 is formed in a convex shape curved from the end surface to the outer surface in this embodiment but may be formed in a column shape in which the end surface and the outer surface are connected through a chamfer as illustrated in FIG. 5 to FIG. 7. In FIG. 5 to FIG. 7, the end surface of the electrode tip 50 is flat for convenience.

Next, the action of the pair of universal joints 30, which is an angle correction mechanism, is explained. The pair of electrodes 20 each correct the tilt angle to the steel sheets M through the action of the pair of universal joints 30, and both electrode tips 50 and 50 on the movable side and the fixed side are brought into contact with the steel sheets M substantially perpendicularly.

Specifically, when the electrode 20 comes into contact with the steel sheets M which are tilted relative to the axis of the electrode 20 as in the left figure of FIG. 5, which schematically illustrates the electrode 20, in the pair of universal joints 30, the first shaft 31 on the side having the electrode tip 50, which is the lower first shaft 31 in FIG. 5, moves rotationally anticlockwise based on the second shaft 32 as in the right figure of FIG. 5, and at the same time, the second shaft 32 moves rotationally clockwise, which is the opposite direction to the rotation direction of the first shaft 31, and bends substantially in a dogleg shape. Thus, the electrode tip 50 comes into contact with the steel sheets M substantially perpendicularly.

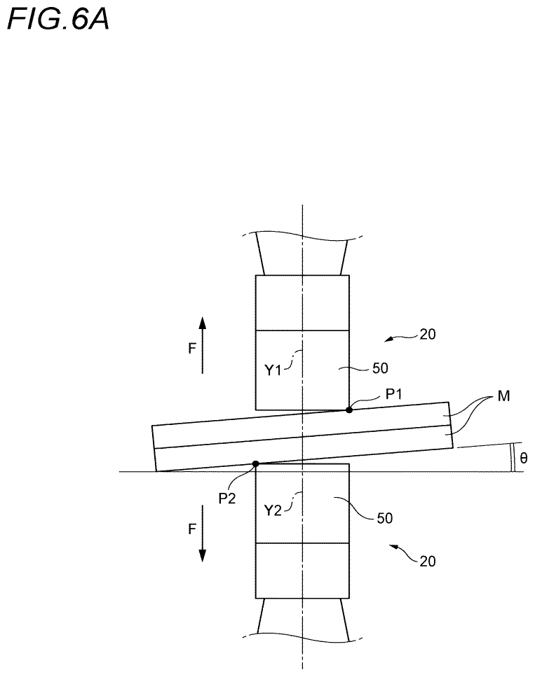

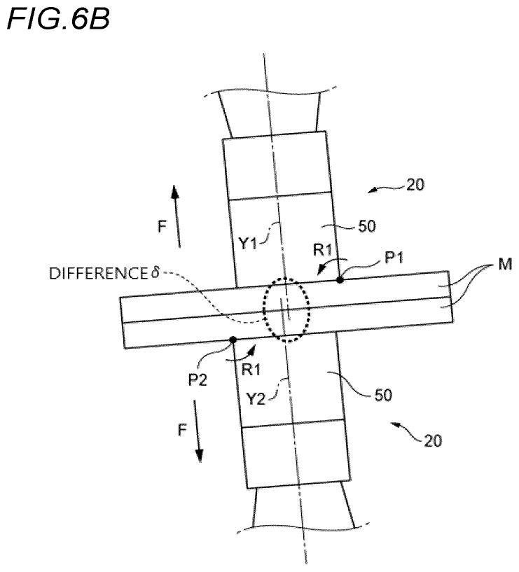

When the pair of electrodes 20 and 20 having the pair of universal joints 30 support the tilted steel sheets M from top and bottom, the electrode tips 50 and 50 come into contact with the steel sheets M at contact points P1 and P2 as illustrated in FIG. 6A, and a load F is applied to the electrodes 20 and 20.

As illustrated in FIG. 6B, both electrode tips 50 and 50 rotate in the directions of the arrows RI around the contact points P1 and P2 through the action of the load F, and the electrode tips 50 come into contact with the steel sheets M substantially perpendicularly. At this point, both electrode tips 50 and 50 rotate around the contact points P1 and P2 to be perpendicular to the steel sheets M, and thus a small difference 6 is caused between the axes Y1 and Y2 of both electrode tips 50 and 50. However, such a difference 6 is small and does not substantially affect the welding quality, and excellent spot welding can be achieved.

The “substantially perpendicular” here means an angle which can be industrially achieved and allows an angle error of 90°±5°, for example.

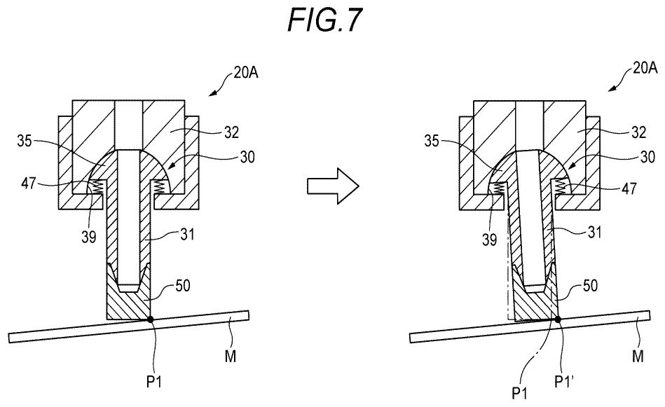

On the contrary, according to a conventional electrode 20A which has only one universal joint 30 in which the engaging portion 35 with a convex spherical shape fits slidably to the engaged portion 39 with a concave spherical shape as illustrated in FIG. 7, a load is applied to the electrode 20A in the state in which the electrode tip 50 is in contact with the steel sheets M at the contact point P1 as in the left figure of FIG. 7 when the steel sheets M are tilted relative to the axis of the electrode 20A.

As in the right figure of FIG. 7, the first shaft 31 turns around the center of curvature of the engaged portion 39 with a concave spherical shape, and the electrode tip 50 comes into contact with the steel sheets M perpendicularly. At this point, the contact point P1 shifts to the contact point P1′. This means that the electrode tip 50 shifts to the right in the figure relative to the steel sheets M. The shift of the electrode tip 50 causes tensile stress and thus is not preferable because LME cracking may be caused.

As explained above, the pair of universal joints 30 of the embodiment acts as an angle correction mechanism which is capable of correcting the angle of the electrode tip 50 to the steel sheets M to correct the tilt angle of the electrode tip 50 and suppresses the shift of the electrode tip 50 relative to the steel sheets M. This means that the pair of upper and lower electrode tips 50 and 50 come into contact with the steel sheets M substantially perpendicularly to the steel sheets M while the shift is suppressed, and thus tensile stress is reduced to suppress LME cracking.

Because the pair of universal joints 30 and 30 are composed as one with the first shafts 31, the second shaft 32 and the cover members 33, which are all rigid, the electrode 20 is highly rigid relative to the axial direction, and the position in the axial direction can be maintained at a certain position even when the load F is applied from the steel sheets M to the electrode 20. Thus, stable resistance spot welding can be conducted.

The load F acting on the electrode 20 is received by the pair of universal joints 30, which are highly rigid, and thus the load F does not act on the coil springs 47. Therefore, the coil springs 47 can be formed with springs which are small to an extend capable of aligning the first shafts 31 and the second shaft 32 in a straight line when the universal joints 30 bend, and a compact electrode 20 can be configured.

Furthermore, because at least the pair of first shafts 31 and the second shaft 32 are formed from a conductive material, an exclusive conductive member for supplying a welding current to the electrode tip 50 is not necessary, and the electrode 20 can be made further compact. There is no concern of hindrance during welding of a narrow part, and a narrow part can be welded easily.

### EXAMPLES

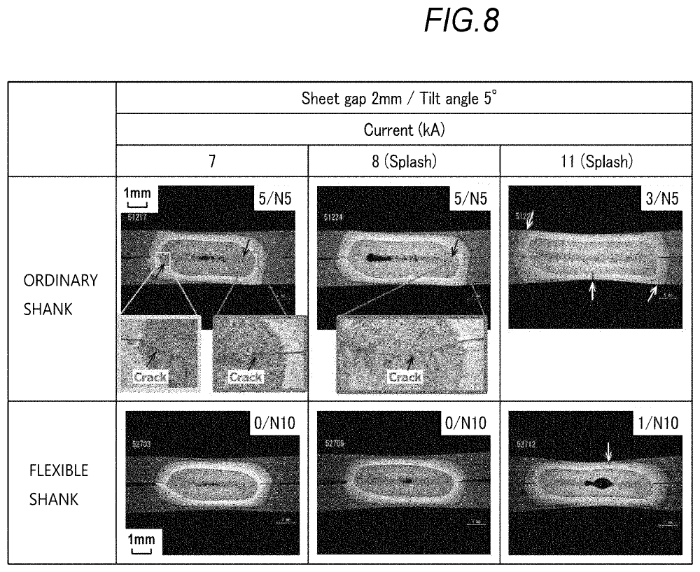

Examples for explaining the effects of the invention are explained below. FIG. 8 includes cross sectional views showing and comparing the joints by resistance spot welding using a conventional resistance spot welding machine in which the electrode on the movable side and the electrode on the fixed side are both rigid electrodes, namely electrodes having no universal joint, and the joints by resistance spot welding using the resistance spot welding machine according to the embodiment in which both electrodes have a pair of universal joints.

The welding conditions were a stack of two steel sheets of GA980DP (galvannealed Dual-Phase steel having a tensile strength of 980 MPa) having a sheet thickness of 1.4 mm, a welding force of 3.5 kN, weld time of 300 ms, holding time of 0.01 sec or more, a sheet gap of 2 mm and a tilt angle of 5°, and a plurality of sets of steel sheets M were spot welded. The welding was conducted under the conditions of a welding current of 7 kA, 8 kA or 11 kA. Spot welding with a welding current of 8 kA or 11 kA is a condition under which splash occurs.

As shown in FIG. 8, by spot welding using the conventional resistance spot welding machine (so-called ordinary shank), LME cracking was caused in most sets of steel sheets M of the five tests as indicated with the arrows in the figure at all the welding currents (7 kA, 8 kA and 11 kA).

On the other hand, by spot welding using the resistance spot welding machine 10 according to the embodiment (so-called flexible shank), LME cracking was not caused except for one case at 11 kA of the ten tests at all the welding currents (7 kA, 8 kA and 11 kA). This is believed to be because of the effects of the correction of the tilt angle to the steel sheets M by the angle correction mechanism of the pair of universal joints 30 provided at each of the electrodes 20 and 20 and the suppression of the shifts of the axes of the electrode tips 50 and 50.

Here, thermal contraction of the nugget due to cooling of the steel sheets M after the current application sometimes causes tensile stress in the thickness direction and thus causes LME cracking in the pressure welded part. Therefore, the holding time for securing the cooling time after welding can reduce the tensile stress in the thickness direction caused due to the thermal contraction of the nugget and is effective for suppressing occurrence of LME cracking. To effectively suppress occurrence of LME cracking, as the holding time, it is preferable to conduct regulation to switch from pressurization with the electrodes to pressure release after holding under pressure for 0.01 sec or more after the completion of the current application.

The invention is not limited to the embodiment and the Example described above, and appropriate modification, improvement and the like are possible.

For example, in the above embodiment, the engaging portions are provided in the first shafts, and the engaged portions are provided in the second shaft. However, the engaged portions may be provided in the first shafts, and the engaging portions may be provided in the second shaft.

Moreover, although the pair of first shafts, the second shaft and the pair of cover members are each composed of a conductive material in the above embodiment, at least the pair of first shafts and the second shaft are composed of a conductive material in the invention.

Furthermore, the angle correction mechanism having the pair of universal joints is provided in each of the pair of electrodes in the embodiment, but the angle correction mechanism may be provided in at least one of the pair of electrodes in the invention.

As described above, the following matters are disclosed in the present specification.

(1) A resistance spot welding machine contains
a pair of electrodes each having an electrode tip to sandwich a plurality of steel sheets, and
an angle correction mechanism that is provided in at least one of the pair of electrodes and that is capable of correcting the angle of the electrode tip to the steel sheets and
which spot welds the plurality of steel sheets by sandwiching the plurality of steel sheets with the pair of electrode tips and applying current while a welding force is applied to the pair of electrode tips,
in which the angle correction mechanism has a pair of universal joints each having an engaging portion having an end with a convex spherical shape and an engaged portion having a concave spherical shape to which the engaging portion fits slidably, and
in which the electrode is capable of applying current to the electrode tip through the pair of universal joints.

According to the configuration, the tilt angle of the electrode tip to the steel sheets can be corrected even when the steel sheets are tilted relative to the axis of the electrode, and a compact electrode can be configured.

(2) The resistance spot welding machine according to (1),
wherein the pair of universal joints contains a pair of first shafts having the engaging portions, a second shaft having a part of both of the engaged portions at both ends in an axial direction of the second shaft and a pair of cover members which are attached to both of the ends of the second shaft in the axial direction and which have a remaining part of both of the engaged portions, and
at least the pair of first shafts and the second shaft are composed of a conductive material.

According to the configuration, universal joints which can be used as a conductive path for a welding current can be formed with a simple mechanism, and a compact electrode can be configured.

(3) The resistance spot welding machine according to (2), wherein the electrode further has an elastic member which is placed between the first shaft and the second shaft around the first shaft and the second shaft and which is capable of aligning the first shaft and the second shaft of the bent universal joint in a straight line.

According to this configuration, the electrode which bends during welding due to the action of the angle correction mechanism can be automatically returned to the original state after the completion of welding.

(4) The resistance spot welding machine according to any one of (1) to (3), wherein the electrode tip has an end surface having a curvature radius R of R≥40 mm and an outer diameter φ of φ≤16 mm.

According to this configuration, the electrode tips are prevented from being partially in contact with the steel sheets, and the electrode tips can come into contact with the steel sheets certainly.

(5) A resistance spot welding method for spot welding a plurality of steel sheets with the resistance spot welding machine according to any one of (1) to (4), the plurality of steel sheets including a galvanized steel sheet and a steel sheet containing 0.08 mass % or more of C and 0.50 mass % or more of Si and having a tensile strength of 980 MPa or more, or including a plurality of steel sheets having at least one galvanized steel sheet containing 0.08 mass % or more of C and 0.50 mass % or more of Si and having a tensile strength of 980 MPa or more.

According to this configuration, occurrence of LME cracking in the pressure welded part in the resistance spot welded joint can be suppressed in resistance spot welding of a plurality of steel sheets including a galvanized steel sheet and a high tensile strength steel sheet or a plurality of steel sheets including a galvanized high tensile strength steel sheet.

(6) The resistance spot welding method according to (5) including holding under pressure for 0.01 sec or more after the completion of the current application and then conducting regulation to switch from pressurization with the electrodes to pressure release.

According to this configuration, the tensile stress in the thickness direction caused due to the thermal contraction of the nugget can be reduced, and occurrence of LME cracking can be suppressed.

The embodiments have been explained above referring to the drawings, but it is needless to mention that the invention is not limited to the examples. It is obvious that one skilled in the art can achieve various types of changed examples or modified examples in the scope described in the claims, and the examples are of course understood to belong to the technical scope of the invention. The constituent elements in the embodiments may be freely combined in the scope which does not depart from the purpose of the invention.

The present application is based on a Japanese patent application (patent application No. 2021-169865) filed on Oct. 15, 2021, and the contents thereof are incorporated in the present application by reference.

### REFERENCE SIGNS LIST

10 Resistance spot welding machine
20 Electrode
30 Universal joint (angle correction mechanism)
31 First shaft
32 Second shaft
33 Cover member
35 Engaging portion
39 Engaged portion
41 Hole portion
47 Coil spring (elastic member)
50 Electrode tip
M Steel sheet
R Curvature radius of end surface of electrode tip
φ Outer diameter of end surface of electrode tip

1. A resistance spot welding machine comprising:
a pair of electrodes each having an electrode tip to sandwich a plurality of steel sheets; and
an angle correction mechanism that is provided in at least one of the pair of electrodes and that is capable of correcting the angle of the electrode tip to the steel sheets,
wherein the resistance spot welding machine spot welds the plurality of steel sheets by sandwiching the plurality of steel sheets with the pair of electrode tips and applying current while a welding force is applied to the pair of electrode tips,
wherein the angle correction mechanism has a pair of universal joints each having
an engaging portion having an end with a convex spherical shape and
an engaged portion having a concave spherical shape to which the engaging portion fits slidably, and
wherein the electrode is capable of applying current to the electrode tip through the pair of universal joints.

2. The resistance spot welding machine according to claim 1, wherein the pair of universal joints comprises
a pair of first shafts having the engaging portions,
a second shaft having a part of both of the engaged portions at both ends in an axial direction of the second shaft of the second shaft, and
a pair of cover members which are attached to both of the ends of the second shaft in the axial direction and which have a remaining part of both of the engaged portions, and
at least the pair of first shafts and the second shaft are composed of a conductive material.

3. The resistance spot welding machine according to claim 2, wherein the electrode further has an elastic member which is placed between the first shaft and the second shaft around the first shaft and the second shaft and which is capable of aligning the first shaft and the second shaft of the bent universal joint in a straight line.

4. The resistance spot welding machine according to claim 1, wherein the electrode tip has an end surface having a curvature radius R of R≥40 mm and an outer diameter φ of φ<16 mm.

5. A resistance spot welding method for spot welding a plurality of steel sheets with the resistance spot welding machine according to claim 1,
wherein the plurality of steel sheets comprises a galvanized steel sheet and a steel sheet containing 0.08 mass % or more of C and 0.50 mass % or more of Si and having a tensile strength of 980 MPa or more, or
wherein the plurality of steel sheets comprises at least one galvanized steel sheet containing 0.08 mass % or more of C and 0.50 mass % or more of Si and having a tensile strength of 980 MPa or more.

6. The resistance spot welding method according to claim 5 including holding under pressure for 0.01 sec or more after the completion of the current application and then conducting regulation to switch from pressurization with the electrodes to pressure release.

7. A resistance spot welding method for spot welding a plurality of steel sheets with the resistance spot welding machine according to claim 4,
wherein the plurality of steel sheets comprises a galvanized steel sheet and a steel sheet containing 0.08 mass % or more of C and 0.50 mass % or more of Si and having a tensile strength of 980 MPa or more, or
wherein the plurality of steel sheets comprises at least one galvanized steel sheet containing 0.08 mass % or more of C and 0.50 mass % or more of Si and having a tensile strength of 980 MPa or more.

8. The resistance spot welding method according to claim 7 including holding under pressure for 0.01 sec or more after the completion of the current application and then conducting regulation to switch from pressurization with the electrodes to pressure release.
